(19) United States
(12) Patent Application Publication
(10) Pub. No.: US 2016/0347266 A1
(43) Pub. Date: Dec. 1, 2016

(54) Protective guard for the outer surface of an automobile

(71) Applicant: Kyle Edwin Mathis, Marina Del Rey, CA (US)

(72) Inventor: Kyle Edwin Mathis, Marina Del Rey, CA (US)

(21) Appl. No.: 14/725,889

(22) Filed: May 29, 2015

(51) Int. Cl. B60R 13/04

(52) U.S. Cl. CPC B60R 13/04

(57) ABSTRACT

Example embodiments are directed to an example of a removable, bumper-like padding that protects the exterior of an automobile from scratches or minor impacts. Example embodiments temporarily engage with the vehicle by a fastening means. The fastening means provides a protuberance with an end stop. The protuberance goes through the padding to engage it with and between the car frame and the closed door, car hatch or car trunk, holding it in place by friction. The hole in the padding can receive the protuberance vertically or horizontally, depending on how the protuberance is directed into the hole.

### TECHNICAL FIELD

The present disclosure relates to removable, bumper-like paddings that protect the exterior of an automobile from scratches or minor impacts.

### BACKGROUND

Cars parked closely together risk being inadvertently hit or scratched by an adjacent car door, such as in a parking lot, when a passenger or driver exits their car. Owners want to keep their vehicles looking new, and seek to protect the outer surfaces of their vehicles with coverings or paddings. Such coverings or paddings may be made of materials like castable elastomers, polyethylenes or other rigid plastics.

### SUMMARY

An example of the present disclosure is a removable, bumper-like padding that protects the exterior of the car from scratches or minor impacts. The present disclosure has at least one fastening protuberance that secures the padding to the interior closure of a car door, hatch, or hood; and an exterior padding that covers a portion of the car's exterior and serves to absorb minor impacts, such as those inflicted inadvertently when an adjacent car door is opened or when a shopping carriage hits the car.

Other objects and features will become apparent from the following detailed description, considered together with the accompanying drawings. The drawings illustrate but do not define the limits of the invention.

### BRIEF DESCRIPTION OF THE DRAWINGS

To assist those with skill in the art of making and using the disclosed protective padding and associated methods, reference is made to the accompanying figures, wherein:

FIG. 1 is a perspective view of the assembled embodiment;

FIG. 2 is an exploded view of the embodiment of FIG. 1;

FIG. 3 is a perspective view of the present embodiment in situ, mounted on an automobile;

FIG. 4 is a detailed, overhead view of the present embodiment in situ, mounted on an automobile.

FIG. 5 is a perspective view of the present embodiment in another position, in situ, mounted on an automobile.

### DESCRIPTION

As discussed in greater detail below, a protective, bumper-like padding is provided that engages with the body of an automobile to protect the outer surface of the automobile from scratches and minor impacts. A means of attachment is a protuberance, placed between the door and the frame, that secures the protective padding onto the exterior of the automobile, and in place once the door, hatch or hood is closed. The protuberance may be engaged with the pad in a vertical or horizontal configuration. A cross-shaped slot in the pad allows the protuberance to be engaged with the pad in either a vertical or horizontal configuration.

A complete understanding of the components, processes and apparatuses disclosed herein can be obtained by referring to the accompanying figures. These figures are intended to demonstrate the present disclosure and are not intended to show relative sizes and dimensions, or to limit the scope of the disclosed embodiment(s). In particular, the figures provided herein are not necessarily to scale and, in certain views, parts may be exaggerated for purposes of clarity.

Although specific terms are used in the following description, these terms are intended to refer only to particular structures in the drawings and are not intended to limit the scope of the present disclosure. It is to be understood that like numeric designations refer to components of like function.

The term “about” or “approximately,” when used with a quantity, includes the stated value and has the meaning dictated by the context. For example, it includes at least the degree of error associated with the measurement of the particular quantity. When used in the context of a range, the term “about” or “approximately” should also be considered as disclosing the range defined by the absolute values of the two endpoints. For example, the range “from about 2 to about 4” or “from approximately 2 to approximately 4” also discloses the range “from 2 to 4.”

In an example embodiment, the present disclosure relates to a bumper-like padding having an engagement means for temporarily fastening the pad to the surface of an automobile. The engagement means is intended to hold the padding proximal to an outer surface of the automobile by which a fastener is inserted into a slot in the padding, then press-fit between a frame portion of the vehicle and a closing portion. In some embodiments the fastener holds the padding between a door and the frame. One skilled in the art understands that the same means for temporarily fastening a form by placing a protuberance in a vertical configuration, between a door and its frame, may be used to temporarily attach it to a different surface of a vehicle by orienting the protuberance horizontally and inserting it through the padding and between the hood and frame, or through the trunk (or hatch) and the frame.

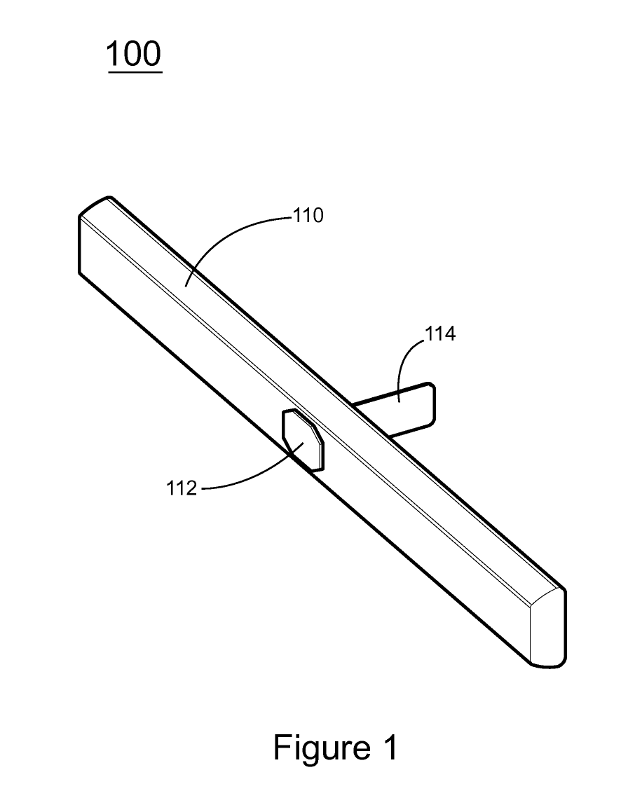

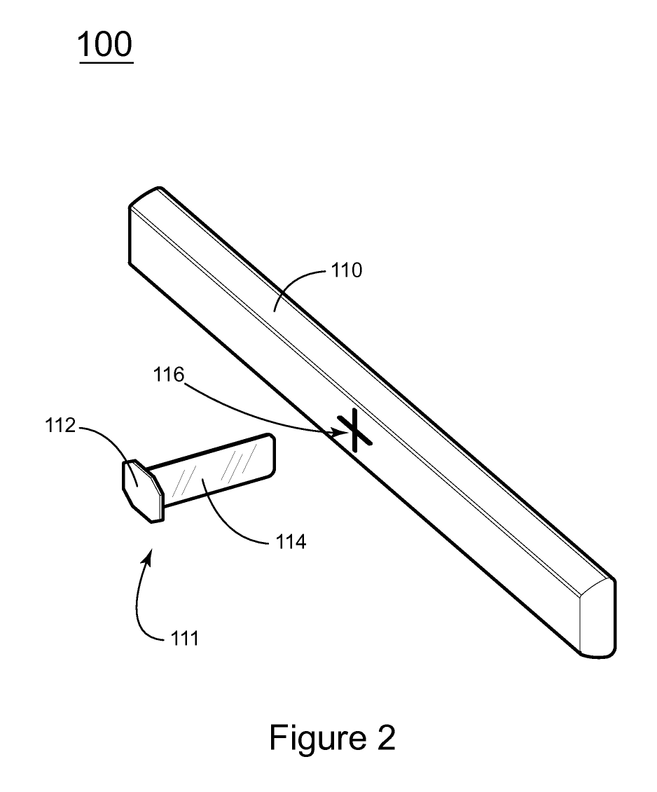

Referring to FIG. 1 and FIG. 2, a type of padding 110 may be manufactured, by extrusion, of any formable polymer that has rubber-like properties. (One type of formable polymer is known as a castable elastomer). A fastening means 111, which may be manufactured of a rigid polymer, comprises a protuberance 114 and an end-stop 112. Together the protuberance 114 and end-stop make up a fastening means 111. The protuberance is inserted through a cross-shaped hole 116 in the padding 110 and may be inserted into the cross-shaped hole 116 in a vertical or horizontal configuration. The fastening means 111 is shown in FIG.s 1 and 2 in a vertical orientation. The end-stop 112 prevents the protuberance 114 from continuing through the hole. This end-stop resides proximal to a surface of the padding 110.

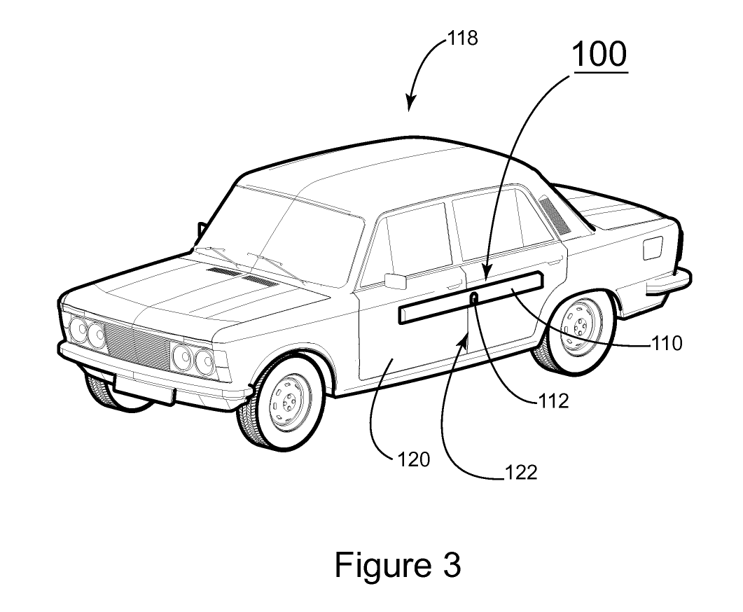

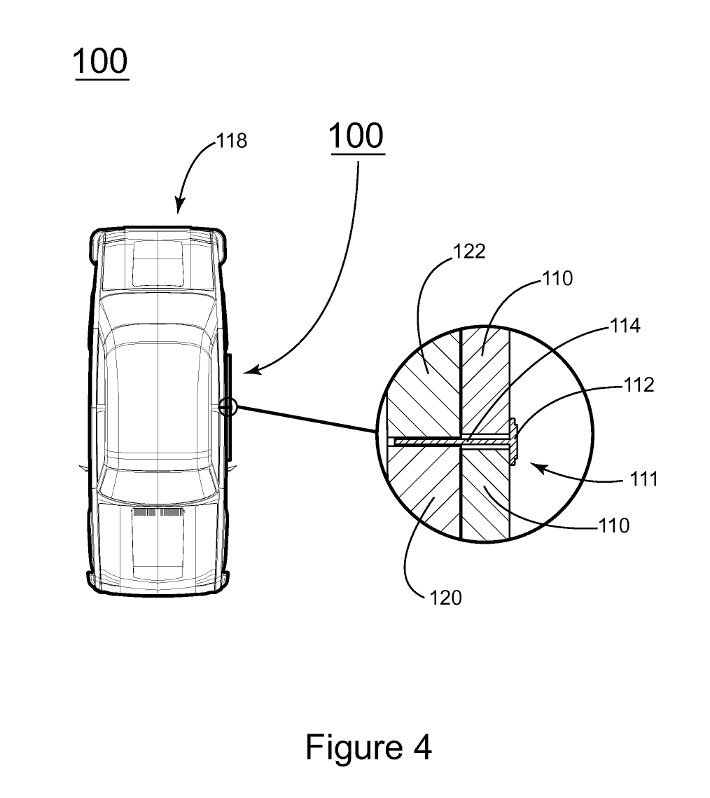

Referring to FIG. 3 and FIG. 4, the embodiment 100 is shown in situ, temporarily attached to the side of an automobile 118. The embodiment 100 may be placed in position against the outer surface of the door 120 of the vehicle, with the protuberance 114 proximal to that part of the door distal to the hinge. When the door is shut, the protuberance 114 is held by a friction-fit such that it is secured between the door 120 and the frame 122. The end-stop 112 provides a fastening means for the padding 110, prohibiting the padding from slipping off the protuberance 114, which is held fast to the vehicle by friction-fit between the door 120 and frame 122.

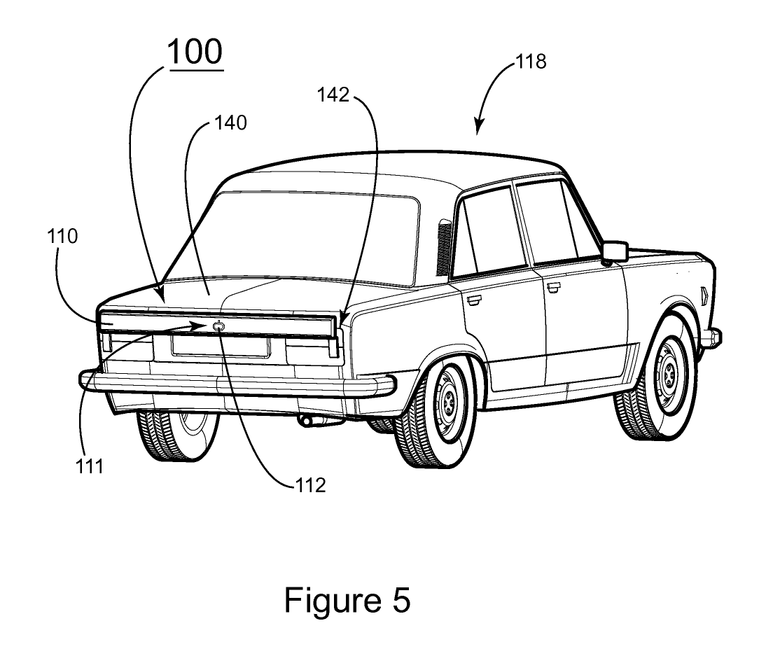

Referring to FIG. 5, the embodiment 100 is shown in situ, temporarily attached to the rear of an automobile 118. The embodiment 100 may be placed in position against the outer surface of the trunk lid 140 of the vehicle, with the protuberance 114 proximal to that part of the lid that is distal to the hinge. When the lid is shut, the protuberance FIGS. 2 and 4, 114 is held by a friction-fit such that it is secured between the lid FIG. 5, 140 and the frame 142. The end-stop 112 provides a fastening means for the padding 110, prohibiting the padding from slipping off the protuberance FIGS. 2 and 4, 114 that is held fast to the vehicle by friction-fit between the lid FIG. 5, 140 and frame 142. One skilled in the art understands that a similar manner of engagement will allow the same padding to be placed on the hood of the vehicle.

While example embodiments have been described herein, it is expressly noted that these embodiments should not be construed as limiting, but rather that additions and modifications to what is expressly described herein also are included within the scope of the invention. Moreover, the features of the various embodiments described herein are not mutually exclusive and can exist in various combinations and permutations, even if such combinations or permutations are not made express herein, without departing from the spirit and scope of the invention.

1. A protective padding for the outer surface of an automobile, in combination with a temporary fastening means, comprising a moldable polymer form having a hole that receives a fastening means; and
said fastening means having a protuberance and an end-cap; such that
the protuberance passes through the aforementioned hole in the padding and the end-stop is sufficiently broad so as not to fit through the hole; and
the fastening means providing temporary attachment to a side of an automobile; wherein
the protuberance is placed between the opening portion of the vehicle and the frame of the vehicle; and
the protuberance is sufficiently thick enough as to provide minimum interference between the opening portion of the vehicle and the frame of the vehicle and thus is held in place by a closed vehicle opening portion.

2. The embodiment of claim one wherein the minimum interference is between 0.01″ and 0.1″.

3. The embodiment of claim one wherein said hole comprises at least 2 intersecting slots, and receives said fastening means in a vertical orientation.

4. The embodiment of claim one wherein said hole comprises at least 2 intersecting slots, and receives said fastening means in a horizontal orientation.

5. The embodiment of claim one wherein the opening portion of the vehicle is a car door.

6. The embodiment of claim one wherein the opening portion of the vehicle is a car trunk.

7. The embodiment of claim one wherein the opening portion of the vehicle is a car hatch.

8. The embodiment of claim one wherein the opening portion of the vehicle is a car hood.
